(19) United States
(12) Patent Application Publication
(10) Pub. No.: US 2006/0216391 A1
(43) Pub. Date: Sep. 28, 2006

(54) Sauce with spanish olives

(76) Inventor: Orosman Delsol, Watertown, NY (US)

Correspondence Address: Orosman Delsol, 440 Portage Street, Watertown, NY, 13601, US

(21) Appl. No.: 11/049,569

(22) Filed: Mar. 22, 2005

(51) Int. Cl. A23L 1/40

(52) U.S. Cl. 426/589

(57) ABSTRACT

A sauce comprises garlic powder, onion powder, Cumin, bay leaves, paprika, oregano, spanish olives, natural tomato, apple cider vinegar, mayonnaise, vegetable oil, parmesan cheese, and brown sugar.

### BACKGROUND OF THE INVENTION

1. Field of the Invention

The present invention relates to a sauce formulation. More particularly the invention relates to a sauce formulation having a unique flavor which results from a unique combination of ingredients.

2. Discussion of the State of the Art

There are many types of sauces available in the conventional marketplace, but many suffer from a variety of drawbacks. Some are made with artificial rather than natural ingredients. Some are heavy in salt and chemicals. Some are not really tasty. The present invention overcomes theses drawbacks, according to the teaching below.

### SUMMARY OF THE INVENTION

In an embodiment of the present invention, a special sauce has, as ingredients, at least garlic powder, onion powder, Cumin, bay leaves, paprika, oregano, spanish olives, natural tomato, apple cider vinegar, mayonnaise, vegetable oil, parmesan cheese, and brown sugar.

In various embodiments of the sauce the ingredients are separately prepared, then at least the Spanish olives and the tomato ingredients are separately ground. Also in various embodiments the Spanish Olive ingredient makes up from 15% to 30% of the sauce by weight.

### BRIEF DESCRIPTION OF THE DRAWING FIGURES

FIG. 1 is a flow diagram illustrating steps in manufacturing a sauce according to an embodiment of the present invention.

### DETAILED DESCRIPTION

The present inventor has invented a unique Sauce he calls Salsa Delsol. Salsa is a Spanish word for “sauce”, and Delsol is the inventors name. Salsa Delsol is made with Spanish olives and all natural ingredients with no salt or other chemicals added.

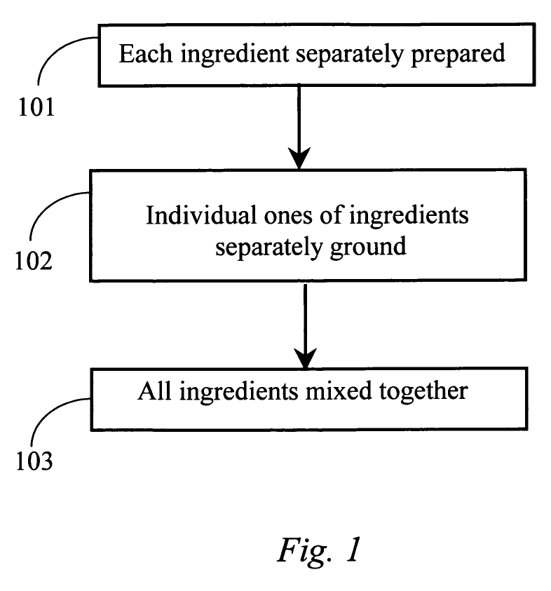

FIG. 1 is a flow diagram illustrating steps in preparation of Salsa Delsol in a preferred embodiment of the invention. In step 101 all of the ingredients, in one embodiment as listed above, are prepared separately. At step 102 some ingredients are separately ground. In step 3 all of the ingredients are mixed together to make the final product. There is no added salt or chemicals, and there are no hot or spicy ingredients in a preferred embodiment.

In a preferred embodiment the ingredients of the salsa are as follows:

| | | |
|---|---|---|
| Garlic Powder | 9.5 | grams |
| Onion Powder | 9.5 | grams |
| Cumin | 9.5 | grams |
| Bay Leaves | 9.5 | grams |
| Paprika | 9.5 | grams |
| Oregano | 9.5 | grams |
| Spanish Olives | 5.7 | oz. (163 grams) |
| Natural Tomato | 18 | oz. (230 grams) |
| Apple Cider Vinegar | 3 | oz. (86 grams) |
| Mayonaise | 4 | oz (115 grams) |
| Vegetable Oil | 4 | oz. (115 grams) |
| Parmesan Cheese | 6 | oz. (172 grams) Finely ground |
| Brown Sugar | 1 | oz. (28.6 grams) |

In a preferred embodiment the Spanish olives, the tomatoes and the parmesan cheese are separately ground, then all of the ingredients are mixed together to make a delicious sauce. The product may be used as a salad dressing, as a dip, as a barbeque sauce, and as a sauce in meats, fish and vegetables.

It will be appreciated by the skilled artisan that there may be other steps and ingredients, and other uses for the sauce, without departing from the spirit and scope of the invention. Therefore the invention is to be limited only by the claims which follow:

I claim:

1. A sauce, comprising:
garlic powder
onion powder
Cumin
bay leaves
paprika
oregano
spanish olives
natural tomato
apple cider vinegar
mayonaise
vegetable oil
parmesan cheese
brown sugar.

2. The sauce of claim 1 wherein the ingredients are separately prepared, then at least the Spanish olives, and the tomato ingredients are separately ground.

3. The sauce of claim 1 wherein the Spanish Olive ingredient makes up from 15% to 30% of the sauce by weight.
